(19) United States
(12) Patent Application Publication
(10) Pub. No.: US 2024/0095391 A1
(43) Pub. Date: Mar. 21, 2024

(54) SELECTING ENTERPRISE ASSETS FOR MIGRATION TO OPEN CLOUD STORAGE

(71) Applicant: INTERNATIONAL BUSINESS MACHINES CORPORATION, Armonk, NY (US)

(72) Inventors: Itai GORDON, Modiin (IL); Shlomit Avrahami Tomer, Jerusalem (IL); Ofer Haim, Rosh Ha'ain (IL); Miriam NIZRI, Jerusalem (IL)

(21) Appl. No.: 17/933,936

(22) Filed: Sep. 21, 2022

(51) Int. Cl. G06F 21/62; G06F 16/21; G06N 5/02

(52) U.S. Cl. CPC G06F 21/6227; G06F 16/214; G06N 5/022

(57) ABSTRACT

A computer-implemented method, a computer system and a computer program product select enterprise assets for migration to open cloud storage. The method includes identifying an asset on a server. The method also includes determining whether the asset contains sensitive information. The method further includes obtaining a migration cost for the asset based on asset attributes. In addition, the method includes calculating a migration score for the asset based on whether the asset contains the sensitive information, access rules for the asset, an asset handling history, and the migration cost. Lastly, the method includes selecting the asset for migration to open cloud storage when the migration score of the asset is above a threshold.

### BACKGROUND

Embodiments relate generally to the field of data storage in remote repositories and more specifically, to selecting enterprise assets for migration to open cloud storage based on attributes of the assets and migration costs.

In today's commercial information technology (IT) environment, it may be efficient for organizations to migrate enterprise assets, e.g., files, databases, containers or virtual machines (VMs) from an on-premises, or wholly controlled by the organization, management environment to the public cloud, which may have advantages including decreased costs or better control resource consumption. In many cases, an organization's enterprise assets are highly sensitive and critical to the success of the organization, and therefore many factors may need to be considered in any migration decision. Many asset management tools employed by organizations may display attributes for each enterprise asset being considered as a migration candidate. Such attributes, along with an understanding of migration costs, may provide an organization with valuable information that may be used to make an informed decision about whether individual enterprise assets, or groups of enterprise assets, may be migrated to open cloud storage.

### SUMMARY

An embodiment is directed to a computer-implemented method for selecting enterprise assets for migration to open cloud storage. The method may include identifying the asset on a server and determining whether the asset contains sensitive information. The method may also include obtaining a migration cost for the asset based on asset attributes. The method may further include calculating a migration score for the asset based on whether the asset contains the sensitive information, access rules for the asset, an asset handling history, and the migration cost. Lastly, the method may include selecting the asset for migration to open cloud storage when the migration score of the asset is above a threshold.

In another embodiment, the method may include displaying the asset and the migration score for the asset to a user. In this embodiment, the method may also include monitoring user interactions with the asset and modifying a selection of the asset for migration to open cloud storage based on the user interactions with the asset.

In a further embodiment, determining that the asset contains the sensitive information may include using a machine learning classification model that predicts a sensitivity of information based on an organizational policy.

In yet another embodiment, obtaining the migration cost for the asset may include transmitting the asset attributes to a cloud provider, where the cloud provider returns the migration cost for the asset based on the asset attributes.

In another embodiment, calculating the migration score for the asset may include associating an initial migration score with the asset, where the initial migration score is based on whether the asset contains the sensitive information. In this embodiment, calculating the migration score for the asset may also include determining a first migration score weight based on the access rules for the asset using a machine learning model that predicts an importance of each access rule in an organizational policy. In this embodiment, calculating the migration score for the asset may further include determining a second migration score weight based on the asset handling history using a machine learning model that predicts an importance of prior access in the organizational policy. In this embodiment, calculating the migration score for the asset may include mapping the migration cost to a third migration score weight and modifying the initial migration score by applying the first migration score weight, the second migration score weight, and the third migration score weight to the initial migration score.

In a further embodiment, selecting the asset for the migration to the open cloud storage may include forwarding the asset to the cloud provider for the migration to the open cloud storage.

In an embodiment, the asset is selected from a group consisting of: a file, a database, a container and a virtual machine (VM).

In addition to a computer-implemented method, additional embodiments are directed to a computer system and a computer program product for selecting enterprise assets for migration to open cloud storage.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for a process that selects enterprise assets for migration to open cloud storage according to an embodiment.

### DETAILED DESCRIPTION

In today's commercial IT environment, it may be more efficient and cost effective for organizations to manage the data, or assets such as files or databases or containers or virtual machines (VMs), that may be generated or maintained by the organizations in open cloud storage or some other public environment that may be maintained by an external cloud provider. Organizations may gain the advantages of such an arrangement but, as a tradeoff, may lose the control over the individual assets that may come with internal management, e.g., security or ease of access. As a result of this tradeoff, organizations might not want to move assets to open cloud storage because of uncertainty about sensitive information in the assets, along with maintaining strict rules as to which users may access which assets, and this may place a premium on the decision of whether to migrate assets to open cloud storage. Most organizational IT departments use internal monitoring tools on data assets that use policies to configure user access to the assets and also have an understanding of whether an asset contains sensitive information. In addition, such tools may also understand the usage pattern of specific assets and track historical data about users and assets for the purpose of information security.

It may therefore be useful to leverage the information, e.g., usage pattern, access history, size and location of assets and whether or not an asset contains sensitive information, that may be collected by the organization through internal management tools and other methods about the assets under internal management to identify resources that may be moved to open cloud storage, i.e., the public cloud, and therefore ease the decision process for migration. Such a method or system may identify an asset as a candidate for migration and determine whether the asset contains sensitive information. The presence of sensitive information in the asset may not immediately disqualify the asset as a migration candidate, but rather this determination may be used in concert with additional information to form a migration score that may be measured against a threshold that may determine whether or not the asset is selected for migration to open cloud storage. The additional information may include access policy rules, which may indicate a number of users and which users are allowed to access the asset. For example, perhaps only users from specific departments or geographic areas within the organization may access a database. Another example may be time based, where users may only be allowed into the database at certain times, which may affect the cost of migration and hosting the asset in the public cloud. The access patterns of users in the organization may be included in the additional information, which may be used for security purposes but could also be useful to determine if the assets may be moved to the cloud. For example, if an asset has a high volume of network traffic at some times but very low most of the time, it may be sensible to move that asset to the cloud. In another example, if data sources are mainly accessed from a specific geographic region and the organization has no internal servers reasonably close to that region, it may be efficient to migrate the asset to a server belonging to a cloud provider in that geographic region. In such a method, a machine learning model may be trained to understand the importance of all the available information about an asset, including creating a profile for the asset that may also be shared with one or more cloud providers to retrieve a migration cost for the asset, which may also be used in the machine learning model to weight migration scores and assist in selecting organizational assets for migration to open cloud storage.

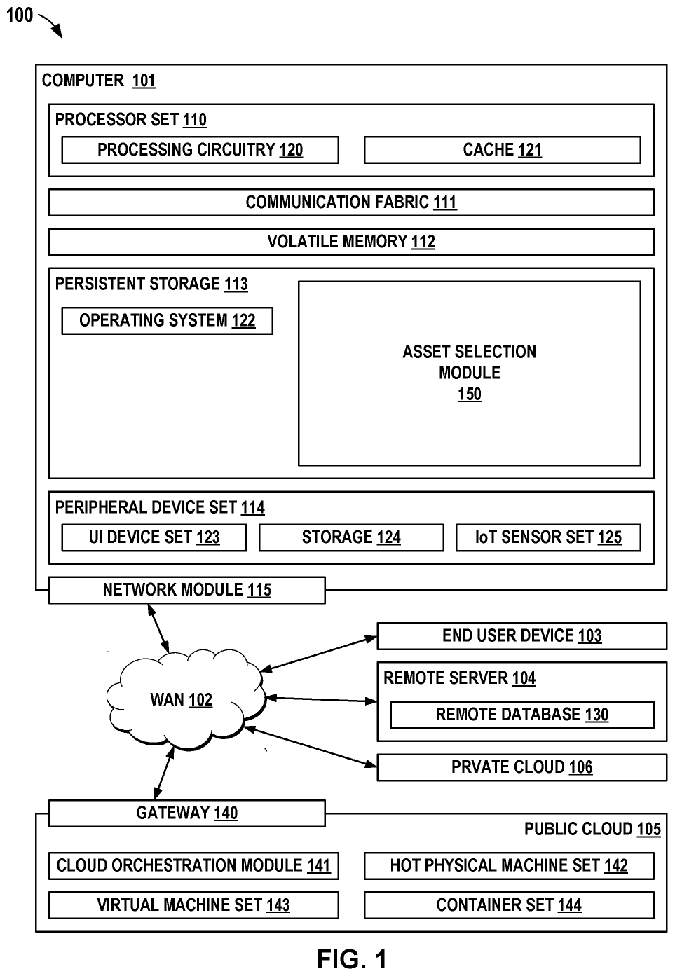

Referring to FIG. 1, computing environment 100 contains an example of an environment for the execution of at least some of the computer code involved in performing the inventive methods, such as asset selection module 150. In addition to asset selection module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and asset selection module 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in asset selection module 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in asset selection module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Computer environment 100 may be used to select enterprise assets for migration to open cloud storage. In particular, asset selection module 150 may identify an asset on a server as a migration candidate and, using information that may be gathered using monitoring tools or any other method, may calculate a migration score based on the information and also a migration cost that be obtained from one or more cloud providers. A threshold may be established for the decision of whether the asset may be migrated to open cloud storage and any asset with a score above the threshold may be migrated automatically by the asset selection module 150 or may be labeled for migration in a list that may be provided to a user, e.g., an administrator within the organization, for validation of the migration score or the decision to migrate the enterprise asset to open cloud storage.

As an example of enterprise assets that may be analyzed by this method or system, consider two internally monitored and maintained databases maintained by an automobile insurance company, both of which contain no sensitive information. In the example, one database holds information about auto repair shops in California that are open on weekends and are preferred by the insurance company, and therefore contains access rules, as noted in the company's monitoring tools, that this database should be accessed only by users in California. In addition, the access history for the database, which is also noted in the monitoring tools, shows that most user access to this database occurs on the weekend. Also in the example, the second database holds the list of all car repair shops in the world that have an agreement with the insurance company. For this database, there are no limitations about accessing this database and no special access pattern is noted in the monitoring tools for the insurance company.

Applying the method described above, the asset selection module 150 may scan the first database and note that there is no sensitive information and then examine the access policy for the access rules, which in the example would determine the limitation that the database may only be accessed from users located in California, followed by discovering from the access history that the database is mostly accessed on weekends.

The asset selection module 150 may also determine at this point any additional information about the database that may be available, e.g., the server currently hosting the database and its physical location, as well as the storage space, or file size, of the database. This additional information may be used to obtain quotes from one or more external cloud providers for a migration cost, or the cost to move each database to open cloud storage, and a maintenance cost, or the cost of performing the monitoring and maintaining functions at the cloud provider, which may be compared to the current costs of internally monitoring and maintaining the databases. The cost information, as well as the information used to obtain the costs, may be stored by the asset selection module 150 in its process.

From the information that has been gathered to this point, a machine learning model may be trained to apply a score or weight to each of the pieces of information that have been gathered for each database in the example. The scores or weights may be applied based on the importance of any specific piece of information to the organization and may also be programmed values or, over time, the machine learning model may learn the importance of an aspect of a database, such as which users access the database or whether the database contains sensitive information, and update the weights based on the acquired knowledge. In the example, if the insurance company places less importance on a database that has no access limitations, then that database may have a higher weight in the migration decision process of the asset selection module 150 than the more restricted database, resulting in a more likely outcome that the database would be selected for migration to open cloud storage.

The machine learning model may compute scores for each of the pieces of information that is present for the asset, or database in the example, and return a migration score for the asset. One of ordinary skill in the art will recognize that, since there are multiple external cloud providers in the market, a single asset may have multiple migration scores based on the costs described above varying by cloud provider. The databases in the example may be ranked by the returned migration score and displayed to an administrator with or without a migration score threshold for a manual decision about migration to open cloud storage or else the asset selection module 150 may use a threshold to automatically make decision about whether the database should be migrated to open cloud storage. The asset selection module 150 may even forward the data automatically to a chosen cloud provider to begin the migration, though this would be a configuration decision by the administrator and consent would be required.

It also should be noted that any migration of an asset that contains sensitive information that may personally identify a specific user requires the informed consent of all people whose information may be present in an enterprise asset. Consent may be obtained in real time or through a prior waiver or other process that informs a subject that their information is present in an enterprise asset that may be migrated to open cloud storage at the discretion of the organization and the user may have the option to remove the information from the asset at that time or in the future, presumably at the time of a potential migration to open cloud storage.

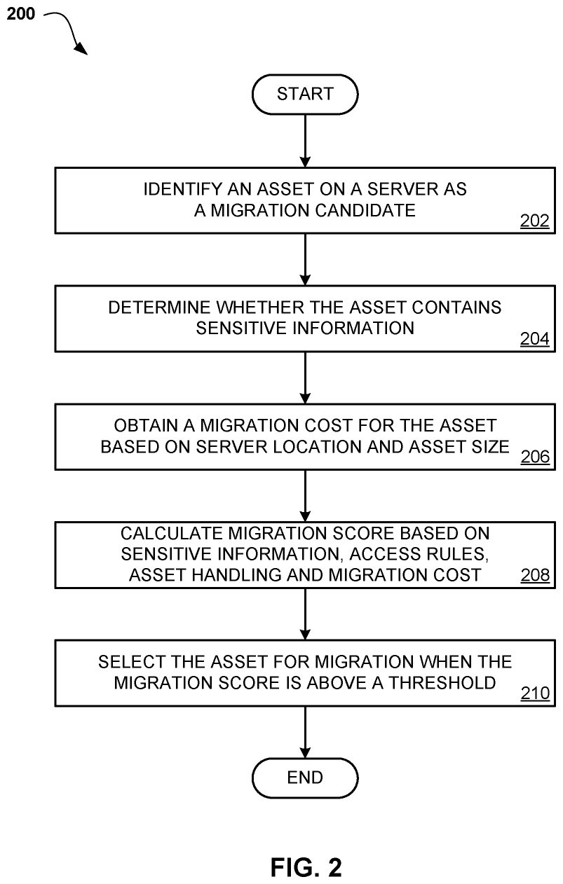

Referring to FIG. 2, an operational flowchart illustrating a process 200 that selects enterprise assets for migration to open cloud storage is depicted according to at least one embodiment. At 202, an enterprise asset may be identified on a server as a migration candidate. Any asset that may currently be under management by an organization may be identified through the management tools of the organization or any other method and also entail identification of various attributes of the enterprise asset that may currently be identified, including an asset handling history, an access policy that may include rules about individual users or groups that may access the enterprise asset, as well as attributes such as a file size or a date/time of creation, “last modified” or “last accessed”. In addition, identification of an enterprise asset may include details about the contents of the asset, which may be accomplished through a real-time search of the contents or through a summarization that may have been done previously by a human creator or administrator using the monitoring tools or other software of the organization, in which case an indicator may be set within the management tool or other software that indicates the presence of sensitive information or some other content that may be of importance to the organization in some way.

At 204, it may be determined whether the identified enterprise asset contains sensitive information. As mentioned above, the contents of the enterprise asset may be scanned by a human user or administrator manually at any time, who may indicate the presence of sensitive information, or may be done using the management tools of the organization or some other software in an automated fashion, perhaps using a machine learning model to learn the organization's standards for sensitive information and implementing the results as a sensitive information policy for enterprise assets within the organization, along with predicting whether enterprise assets in the current analysis contain sensitive information based on an organizational policy. It should be noted that sensitive information may be defined by an organizational policy, e.g., containing a trade secret or business practice details that an organization may wish to protect or keep secret, or may be defined by an individual user or group, e.g., information that personally identifies a specific user or group. The individual decisions for whether or not information is sensitive may be set by an administrator within the organization subject to the policy, an owner of sensitive information in the case of personal information or may also be set according to training data that is put into a machine learning classification model that may make decisions about the sensitivity of information. Depending on the type of sensitive information that may be present in the enterprise asset, an owner of the potentially sensitive information may be required to consent to any information being migrated to open cloud storage.

It should also be mentioned that the owner of sensitive information is free to make decisions with respect to the sensitivity of information at any time and change what they choose to be sensitive information as these settings are permanently retained to allow the owner of the information complete control over their informed consent of the presence of sensitive information in enterprise assets that may have been migrated to open cloud storage.

It is important to note that the presence of sensitive information may not automatically disqualify an enterprise asset from migration to open cloud storage. As will be discussed in more detail below, a weight or migration score that may be calculated for the asset would include the presence of sensitive information in the calculation and it is possible that other factors may outweigh the presence of sensitive information in the enterprise asset. As an example, the access policy may determine that all users are able to read the data, and therefore the information is already public and no longer sensitive, or the access history may show that the data is no longer valid, e.g., the last write to a database was 5 years ago.

At 206, a migration cost for the enterprise asset may be obtained from a cloud provider using attributes of the asset such as the file size of the asset and server location. Cost to migrate an enterprise asset to open cloud storage may vary by provider and greatly affect a decision by an organization over whether the enterprise asset should be migrated to open cloud storage. The file size may indicate an amount of data, and therefore a length of time, which would define a workload for the provider. Also, the server location may affect cloud provider processes, especially if the organization specified to the provider that the enterprise asset must remain in the same local area. One of ordinary skill in the art may recognize that there are many attributes that a cloud provider may use to determine cost and, since cloud provision is a competitive business with many providers, a single enterprise asset may have multiple costs, and therefore multiple migration scores as detailed below.

At 208, a migration score may be calculated for the enterprise asset based on the information that is determined in the prior steps, i.e., the presence of sensitive information and the migration costs obtained from cloud providers, and also on additional information that may be retrieved from the organization's management tools or other software, e.g., an access policy with rules for accessing the enterprise asset and an asset handling history or log that may show how the enterprise asset has been handled in the past.

In an embodiment, a supervised machine learning model may be trained to calculate a migration score that may be compared to a threshold that determines the suitability of an enterprise asset for migration to open cloud storage. The migration score may combine all of the features mentioned above, i.e., the presence of sensitive information, the migration cost, the access policy and asset handling history, as well as any other attributes or features that may be ascertained about the enterprise asset being considered. The attributes or features may be converted into a numerical score that reflects an organization's judgment in the importance of the attribute or feature, along with a weight that may be determined from the degree of presence of the attribute or feature in the current enterprise asset being considered for migration. As an example of attributes that may be determined from the access policy or asset handling history, rules may be established for access to an asset based on time, e.g., accessible only on the weekends as in the example database above, location, e.g., only users in California for the described example, or volume, e.g., only a certain number of users may access the database or only a certain amount of concurrent access to a database. The access policy may overlap with the asset handling history in that information about the actual usage may be extracted using the management tools or other software. This information may include an understanding of the last time a certain access rule was used or how often the rule was used to better understand the suitability of the enterprise asset for migration to open cloud storage. One of ordinary skill in the art would recognize that there are many access rules or patterns that may exist and may be used to train the machine learning model.

At this step, anomalous behavior may also be analyzed and factored into the machine learning. For instance, an enterprise asset that may be rarely accessed and then suddenly accessed very frequently by many users may indicate that an enterprise asset is compromised or is in some way not suitable for migration to open cloud storage. In such a case, a migration score may be weighted to exclude (or include, should the organization decide that such assets should be migrated) the asset from consideration for migration to open cloud storage. In addition to a machine learning model that may be used to calculate the migration score, machine learning may also be used to predict the importance of individual attributes to the organization, such as each of the access rules in an organizational policy or the asset handling history as the activities in such a log may be related to the organization policy. With respect to migration cost, in addition to factoring the migration cost directly as a numerical value, the migration cost may also be mapped to a weight that may be applied to the migration score to better integrate this feature into a calculation for use in selecting an enterprise asset for migration to open cloud storage.

While it may be presented herein that an initial migration score is created through the determination of sensitive information and then weights may be applied according to further attributes of enterprise assets, this order of events is not required and, while an initial migration score may be formed and then weighted based on subsequent analysis, the specific attributes that may be considered in each step of the analysis and calculation are interchangeable and none are considered more important than others. Likewise, there is not a required number of attributes or features of any enterprise asset that may be considered. It is only required that all available information be captured and analyzed to calculate a complete migration score and that an informed decision be made.

One or more of the following machine learning algorithms may be used: logistic regression, naive Bayes, support vector machines, deep neural networks, random forest, decision tree, gradient-boosted tree, multilayer perceptron. In an embodiment, an ensemble machine learning technique may be employed that uses multiple machine learning algorithms together to assure better classification when compared with the classification of a single machine learning algorithm. In this embodiment, training data for the model may include information about prior assets considered for migration or other reasons, such as security or suitability for storage on an organization's servers. The training data may be collected from a single example enterprise asset or a group of assets. The aggregate scores and any associated ranks or classification results may be stored in a database so that the data is most current, and the output would always be up to date.

At 210, the enterprise asset may be selected for migration to open cloud storage when the migration score calculated in the previous step is above a threshold. Selection may include a display of the asset through a user interface to an administrator with the migration score and monitoring the interactions of the administrator with the display of the asset or a group of enterprise assets. The human administrator may provide feedback by validating the decision to migrate the enterprise asset or by overruling the decision made in 208 and this feedback may be used to further refine the calculation of a migration score or a weight that may be placed on the score through the process. It should be noted that a display may include multiple enterprise assets for ease of use and the assets may be ranked by the migration scores, including possible multiple migration scores of a single asset based on the varying migration costs of different cloud providers. Alternatively, selection of an enterprise asset may include automatic forwarding to the cloud provider with the best migration score, in which case the cloud provider may immediately begin migration using its tools or other software. One of ordinary skill in the art will recognize that there are multiple ways to accomplish the migration to open cloud storage. Regarding the threshold, a target score for the organization may be established for selection of an asset for migration that may be preconfigured for the process, including potential custom thresholds for different asset types, e.g., files, databases, etc., and a machine learning model may be used to learn from the attributes or features of various enterprise assets and the migration decisions, along with feedback from administrators regarding the decisions, to modify the threshold according to an organization's needs and policies about migration of enterprise assets to open cloud storage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for selecting enterprise assets for migration to open cloud storage, the method comprising:
identifying the asset on a server;
determining whether the asset contains sensitive information;
obtaining a migration cost for the asset based on asset attributes;
calculating a migration score for the asset based on whether the asset contains the sensitive information, access rules for the asset, historical handling of the asset, and the migration cost; and
selecting the asset for migration to open cloud storage when the migration score of the asset is above a threshold.

2. The computer-implemented method of claim 1, further comprising:
displaying the asset and the migration score for the asset to a user;
monitoring user interactions with the asset; and
modifying a selection of the asset for migration to open cloud storage based on the user interactions with the asset.

3. The computer-implemented method of claim 1, wherein determining that the asset contains the sensitive information uses a machine learning classification model that predicts a sensitivity of information based on an organizational policy.

4. The computer-implemented method of claim 1, wherein obtaining the migration cost for the asset further comprises transmitting the asset attributes to a cloud provider, wherein the cloud provider returns the migration cost for the asset based on the asset attributes.

5. The computer-implemented method of claim 1, wherein calculating the migration score for the asset further comprises:
associating an initial migration score with the asset, wherein the initial migration score is based on whether the asset contains the sensitive information;
determining a first migration score weight based on the access rules for the asset using a machine learning model that predicts an importance of each access rule in an organizational policy;
determining a second migration score weight based on the historical handling of the asset using a machine learning model that predicts an importance of prior access in the organizational policy;
mapping the migration cost to a third migration score weight; and
modifying the initial migration score by applying the first migration score weight, the second migration score weight, and the third migration score weight to the initial migration score.

6. The computer-implemented method of claim 4, wherein the selecting the asset for the migration to the open cloud storage further comprises forwarding the asset to the cloud provider for the migration to the open cloud storage.

7. The computer-implemented method of claim 1, wherein the asset is selected from a group consisting of: a file, a database, a container and a virtual machine (VM).

8. A computer system for selecting enterprise assets for migration to open cloud storage, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying the asset on a server;
determining whether the asset contains sensitive information;
obtaining a migration cost for the asset based on asset attributes;
calculating a migration score for the asset based on whether the asset contains the sensitive information, access rules for the asset, historical handling of the asset, and the migration cost; and
selecting the asset for migration to open cloud storage when the migration score of the asset is above a threshold.

9. The computer system of claim 8, further comprising:
displaying the asset and the migration score for the asset to a user;
monitoring user interactions with the asset; and
modifying a selection of the asset for migration to open cloud storage based on the user interactions with the asset.

10. The computer system of claim 8, wherein determining that the asset contains the sensitive information uses a machine learning classification model that predicts a sensitivity of information based on an organizational policy.

11. The computer system of claim 8, wherein obtaining the migration cost for the asset further comprises transmitting the asset attributes to a cloud provider, wherein the cloud provider returns the migration cost for the asset based on the asset attributes.

12. The computer system of claim 8, wherein calculating the migration score for the asset further comprises:
associating an initial migration score with the asset, wherein the initial migration score is based on whether the asset contains the sensitive information;
determining a first migration score weight based on the access rules for the asset using a machine learning model that predicts an importance of each access rule in an organizational policy;
determining a second migration score weight based on the historical handling of the asset using a machine learning model that predicts an importance of prior access in the organizational policy;
mapping the migration cost to a third migration score weight; and
modifying the initial migration score by applying the first migration score weight, the second migration score weight, and the third migration score weight to the initial migration score.

13. The computer system of claim 11, wherein the selecting the asset for the migration to the open cloud storage further comprises forwarding the asset to the cloud provider for the migration to the open cloud storage.

14. The computer system of claim 8, wherein the asset is selected from a group consisting of: a file, a database, a container and a virtual machine (VM).

15. A computer program product for selecting enterprise assets for migration to open cloud storage, the computer program product comprising:
a computer-readable storage device having program instructions embodied therewith, the program instructions executable by a processor to cause the processor to perform a method comprising:
identifying the asset on a server;
determining whether the asset contains sensitive information;
obtaining a migration cost for the asset based on asset attributes;
calculating a migration score for the asset based on whether the asset contains the sensitive information, access rules for the asset, historical handling of the asset, and the migration cost; and
selecting the asset for migration to open cloud storage when the migration score of the asset is above a threshold.

16. The computer program product of claim 15, further comprising:
displaying the asset and the migration score for the asset to a user;
monitoring user interactions with the asset; and
modifying a selection of the asset for migration to open cloud storage based on the user interactions with the asset.

17. The computer program product of claim 15, wherein determining that the asset contains the sensitive information uses a machine learning classification model that predicts a sensitivity of information based on an organizational policy.

18. The computer program product of claim 15, wherein obtaining the migration cost for the asset further comprises transmitting the asset attributes to a cloud provider, wherein the cloud provider returns the migration cost for the asset based on the asset attributes.

19. The computer program product of claim 15, wherein calculating the migration score for the asset further comprises:
associating an initial migration score with the asset, wherein the initial migration score is based on whether the asset contains the sensitive information;
determining a first migration score weight based on the access rules for the asset using a machine learning model that predicts an importance of each access rule in an organizational policy;
determining a second migration score weight based on the historical handling of the asset using a machine learning model that predicts an importance of prior access in the organizational policy;
mapping the migration cost to a third migration score weight; and
modifying the initial migration score by applying the first migration score weight, the second migration score weight, and the third migration score weight to the initial migration score.

20. The computer program product of claim 18, wherein the selecting the asset for the migration to the open cloud storage further comprises forwarding the asset to the cloud provider for the migration to the open cloud storage.
